(19) United States
(12) Patent Application Publication
(10) Pub. No.: US 2004/0011403 A1
(43) Pub. Date: Jan. 22, 2004

(54) System for sensing fluid and activating a controller in response to fluid being sensed

(76) Inventor: John R. Martin, Naples, FL (US)

Correspondence Address: Patrick C. Keane, BURNS, DOANE, SWECKER & MATHIS, L.L.P., P.O. Box 1404, Alexandria, VA, 22313-1404, US

(21) Appl. No.: 10/198,087

(22) Filed: Jul. 19, 2002

(51) Int. Cl. G05D 7/06

(52) U.S. Cl. 137/312

(57) ABSTRACT

A system senses for fluid and activates a controller in response to sensing the fluid including a controller for actuating a valve used to control fluid flow, at least one detector including: a sensing circuit for detecting a voltage change due to the fluid and generating an oscillating output signal; and a transmitting circuit connected to the sensing circuit for transmitting a pulsed signal in response to the oscillating output signal; and a base receiver including: a triggering circuit for activating the controller, a receiver circuit for receiving the pulsed signal from the transmitting circuit and enabling the triggering circuit and a back-up power source for supplying power to the base receiver and the controller when an external power source is insufficient to actuate the valve.

### BACKGROUND

1. Field of the Invention

The present invention relates to a system for the detection or the sensing of a fluid.

2. Background Information

Water lines provide water to bathrooms, sinks, drinking fountains, washing machines and water heaters in residential or commercial dwellings. Water line breaks or water leaks occur in high rise condominiums, office buildings, apartment buildings and in other types of commercial establishments. Water line breaks and water leaks also occur in residential dwellings. Damage resulting from water line breaks or water leaks can be extensive if not detected quickly so that the water can be shutoff.

Water lines also provide water to sprinklers and irrigation systems for watering vegetation. For example, the soil for grass on a golf course or potted plants in a greenhouse is watered when the soil becomes dry. Typically, the desire in watering grass is to water the soil until the soil is damp to a predetermined depth. The desire in watering potted plants is to water until the catch basin under the plant is full of water.

### SUMMARY

It would be desirable to have a system that can sense a fluid and control the flow of the fluid in response to a sensing of the fluid.

Exemplary embodiments of the present invention are directed to a system that senses for fluid and activates a controller in response to sensing the fluid including a controller for actuating a valve used to control fluid flow, at least one detector including: a sensing circuit for receiving a voltage and generating an oscillating output signal and a transmitting circuit connected to the sensing circuit for transmitting a pulsed signal in response to the oscillating output signal; and a base receiver including: a triggering circuit for activating the controller, a receiver circuit for receiving the pulsed signal from the transmitting circuit and enabling the triggering circuit and a back-up power source for supplying power to the base receiver and the controller when an external power source is insufficient to actuate the valve.

In accordance with exemplary embodiments of the invention, a detector for sensing fluid include a first probe and a second probe for sensing a fluid, wherein a voltage is supplied to the second probe from the first probe when a fluid is sensed, a logic gate having a first input connected to the second probe, a second input and an output, an output signal control circuit connected to the second input and to the output of the logic gate for controlling an output signal from the logic gate, and a transmitting circuit for transmitting a signal representing sensing of the fluid based upon the output signal from the output of the logic gate.

Exemplary embodiments include a base receiver for activating a controller include a receiving circuit for receiving a signal and having an output for emitting a trigger signal, a trigger logic circuit having an input connected to the output of the receiving circuit, a reset input and a second output, a first capacitor having a first node connected to the output of the trigger logic circuit and a second node, and a firing circuit having an input connected to the second node of the first capacitor and an output for activating a controller that actuates a valve.

In accordance with exemplary embodiments of the invention, a fluid detection system for activating a controller in response to sensing a presence of fluid includes a valve for controlling fluid flow, a controller for actuating the valve a first and second probe, a sensing circuit for detecting a voltage change between the first and second probe due to the presence of fluid, a first capacitor for discharging a first voltage to activate the controller such that the valve is actuated, and a second capacitor for discharging a second voltage to activate the controller such that the valve is reverse actuated.

### BRIEF DESCRIPTION OF THE FIGURES

Other objects and advantages of the present invention will become apparent to those skilled in the art upon reading the following detailed description of exemplary embodiments, in conjunction with the accompanying drawings, wherein:

FIG. 1 is a functional block diagram of a system in accordance with an exemplary embodiment of the present invention.

FIG. 2 is an exemplary embodiment of a system in accordance with the present invention.

FIG. 3 is a functional block diagram of a detector in accordance with an exemplary embodiment of the present invention.

FIG. 4 is an exemplary schematic for an exemplary embodiment of a detector.

FIG. 5 is a functional block diagram of a base receiver in accordance with an exemplary embodiment of the present invention.

FIG. 6 is an exemplary schematic for an exemplary embodiment of a base receiver.

FIG. 7A is an exemplary schematic for an alternative embodiment of the reset circuit in the exemplary embodiment of a base receiver shown in FIG. 6.

FIG. 7B is an exemplary schematic for an alternative embodiment of the firing circuit in the exemplary embodiment of a base receiver shown in FIG. 6.

FIG. 8 is an exemplary embodiment of a detector using two different voltages for actuating a valve.

### DETAILED DESCRIPTION OF THE PREFERRED EMBODIMENTS

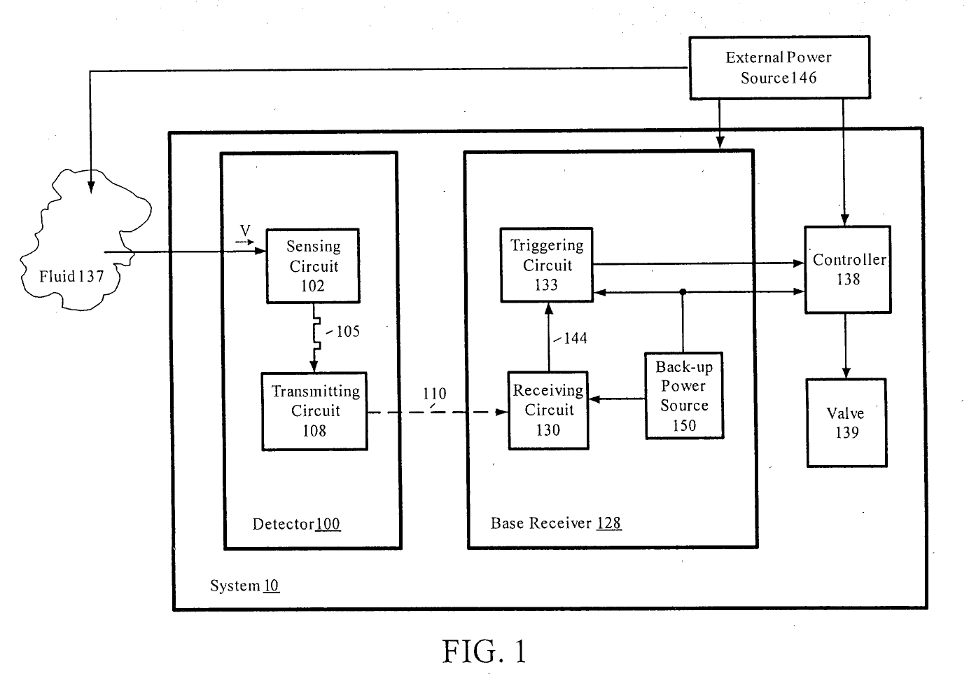

The present invention is directed to a system that senses for fluid and activates a controller to control fluid flow. As shown in FIG. 1, an exemplary embodiment is represented as a system 10 that includes a controller 138 for actuating a valve 139 used to control fluid flow, at least one detector 100 for detecting fluid 137 and a base receiver 128 for activating the controller. The detector 100 of the exemplary embodiment in FIG. 1 includes a sensing circuit 102 for receiving a voltage V via the fluid and generating an output signal 105 when the fluid 137 is sensed. The sensing circuit 102 generates an oscillating signal as an output signal 105. An oscillating output signal requires less power than a steady signal. The detector 100 of the exemplary embodiment in FIG. 1 can also include a transmitting circuit 108 connected to the sensing circuit 102 for transmitting a pulsed signal 110 in response to the output signal 105. The base receiver 128 of the exemplary embodiment in FIG. 1 includes a receiving circuit 130 for receiving the pulsed signal 110 from the transmitting circuit 108 and a triggering circuit 133 for activating the controller 138. In response to receiving the pulsed signal 110, the receiving circuit 130 sends a trigger signal 139 to the triggering circuit 133. The triggering circuit 133 activates the controller 138 in response to the trigger signal 144. The base receiver 128 of the exemplary embodiment in FIG. 1 can also include a back-up power source 150 for supplying power to the receiving circuit 130, the triggering circuit 133 and the controller 138 when an external power source 146 is insufficient to actuate the valve 139.

The system can have one or more detectors that can send a pulsed signal to a base receiver to activate the controller. For example, detectors at different locations can be used to detect water leaks or water line breaks throughout a building and any one detector can shutoff the water. Furthermore, more than one base receiver can receive a signal from one or more detectors such that different controllers can be activated to acuate different valves. In addition, a controller in a base receiver can acuate one or multiple valves.

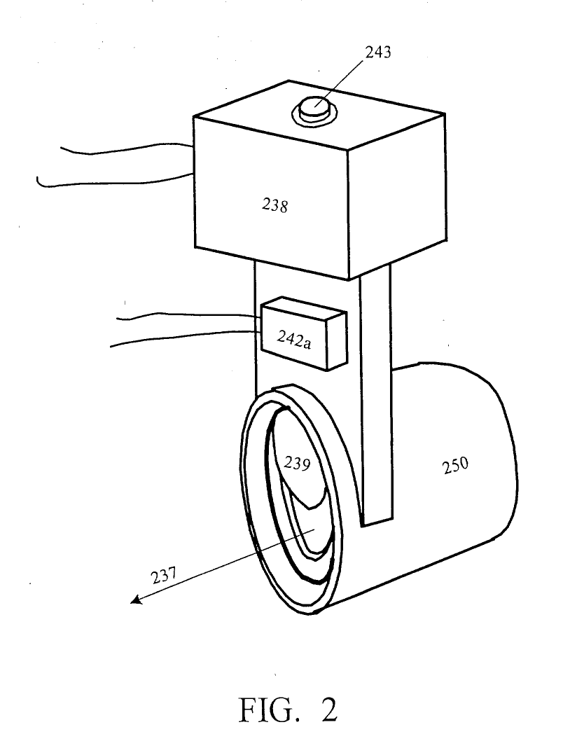

An exemplary embodiment of a valve and a controller is represented in FIG. 2 as a controller 238 for actuating a valve 239 that controls fluid flow 237. The controller 238 can be one of a solenoid, relay, motor, power-pill and any other type of control device. The controller 238 actuates the valve 239, for example, on a water line 250. The valve 239 can be a pilot operated solenoid valve, direct acting solenoid valve, a motor driven valve, bobbin type slide solenoid valve, a power-pill (e.g., heat activated) valve or any other type of valve that can be actuated directly or indirectly. Attached to the controller 238 can be a reset button 243, as shown in FIG. 2.

In the exemplary embodiment of FIG. 2, the controller 238 actuates a valve 239 in a latching fashion with a latching mechanism. The latching mechanism can be a mechanical holding mechanism or magnetic holding system, such that when the controller 238 actuates the valve 239 closed, the valve 239 stays closed without power having to be applied to maintain the valve closed. The controller 238 can close the valve 239 or open the valve 239 depending upon the polarity of the voltage applied across the controller 238. In the exemplary embodiment of FIG. 2, when the controller 238 actuates the valve open, the valve 239 stays open without power having to be applied to maintain the valve open. Relays can be used with a controller to actuate multiple valves since a controller can activate several relays in which each relay provides power to one or more electrically operated valves.

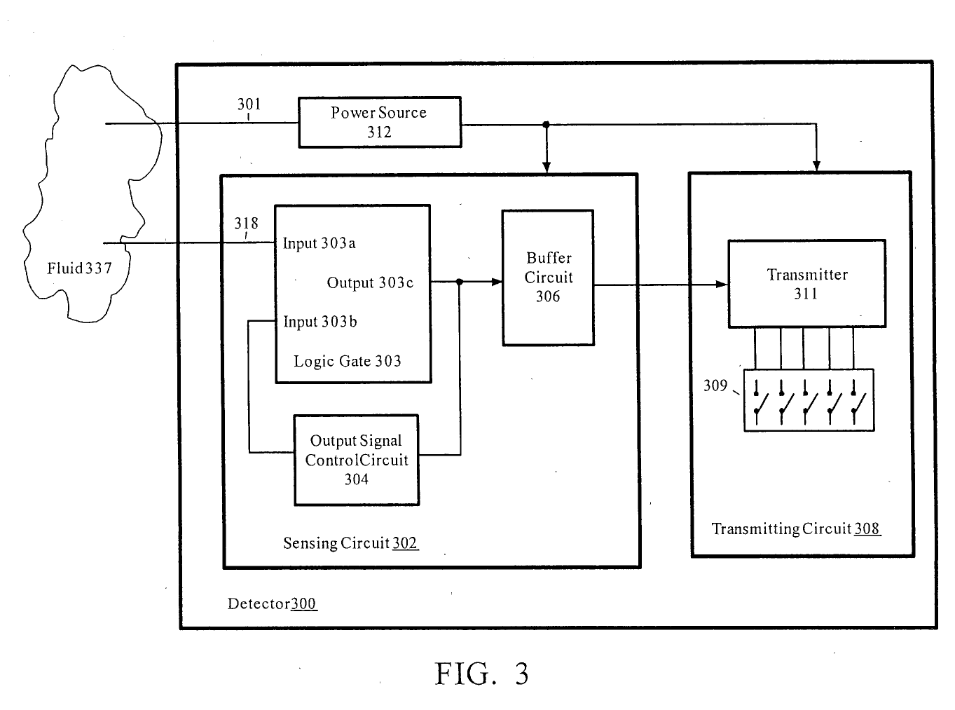

An exemplary embodiment of a detector is represented in FIG. 3 as a detector 300 that includes a first probe 301 and a second probe 318 for sensing a fluid 337. When both the first probe 301 and the second probe 318 are within a fluid 337 or a fluid is sensed, a voltage is applied to the second probe 318 from the first probe 301. The first probe 301 is connected to a power source 312 and the second probe 318 is connected to a sensing circuit 302. The sensing circuit 302 can include a logic gate 303 that has an input 303a connected to the second probe 301, a second input 303b and an output 303c connected to an output signal control circuit 304. The sensing circuit 302 can include a buffer circuit 302 connected between the transmitting circuit and the output of the logic gate for buffering the output signal from the transmitting circuit 308. As shown in the exemplary embodiment of FIG. 3, the transmitting circuit 308 can include a transmitter 311 and a set of switches 309. The switches 309 can, for example, be used to determine types of encoding for the pulsed signals emitted from the transmitter 311.

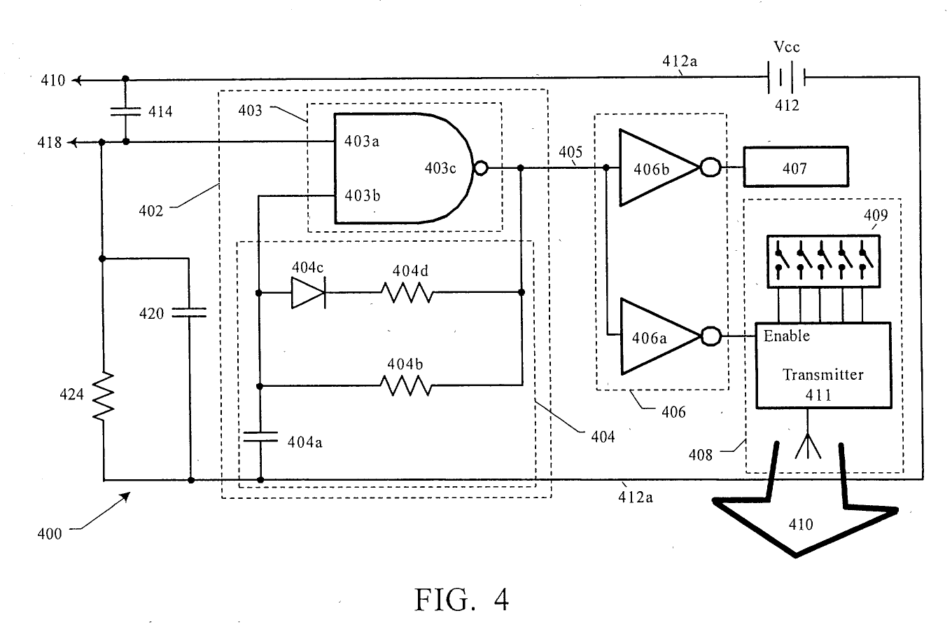

FIG. 4 is a schematic for an exemplary embodiment of a detector represented as a detector 400 that includes a first probe 401 connected to the positive terminal 412a of the battery 412. A second probe 418 is connected to the sensing circuit 402. A buffer circuit 406 can be connected to the sensing circuit 402. A transmitting circuit 408 and alarm 411 connected to the buffer circuit 406. A battery 412 can be used to supply a voltage Vcc to the sensing circuit 402, the transmitting circuit 408, alarm 411 and thereby power any one or more of these devices, and/or any other desired devices.

When both the first probe 401 and the second probe 418 are within a fluid or a fluid is sensed, the voltage Vcc from the battery 412 is applied to the second probe 418 from the first probe 401. The fluid acts as a conductor that interconnects (e.g., short circuits) the first probe 401 and the second probe 418. Therefore, the voltage Vcc of the battery 412 is supplied across the resistor 424 and to the sensing circuit 402. A capacitor, such as electromagnetic interference capacitor 414, can be connected between the first probe 401 and the second probe 418 to prevent false triggers from radio frequency signals. An electrostatic discharge circuit, such as a static biasing resistor 424 and a static capacitor 420, can be connected between the second probe 418 and common ground 426b to prevent a false trigger from static electricity. Any desired filtering can be added or removed as desired depending on, for example, the environment within which the system is used.

As shown in the exemplary embodiment of FIG. 4, the sensing circuit 402 can include a logic gate 403 and an output signal control circuit 404. The logic gate 403 is, for example, a NAND gate having a first input 403a, a second input 403b and an output 403c. The second probe 401 is connected to the first input 403a of the NAND gate 403. The output signal control circuit 404 is connected to the second input 403b of the NAND gate 403, to the output 403c of the NAND gate 403 and common ground 412b of the detector circuit (i.e., the negative terminal of the battery 412).

The output signal control circuit 404 in the exemplary embodiment of FIG. 4 includes a discharge capacitor 404a connected between common ground 412b and the second input 403b of the NAND gate 403, a charging resistor 404b connected between the discharge capacitor 404a and the output 403c of the NAND gate 403, and a discharge diode 404c and a discharging resistor 404d connected in series in between the discharge capacitor 404a and the output 403c of the NAND gate 403.

The exemplary embodiment of FIG. 4 also includes a buffer circuit 406 within the sensing circuit 402 that is connected between the transmitting circuit 408 and the output 403c of the NAND gate 403. The buffer circuit 406 buffers the output signal from an alarm 407 and transmitting circuit 408. The buffer circuit 406 allows the output signal 405 to drive the alarm 411 and enable the transmitting circuit 408 with minimal interference to the operation of the sensing circuit 102. As shown in the exemplary embodiment of FIG. 4, the buffer circuit 406 is, for example, a pair of inverters 406a and 406b that are respectively used for enabling the transmitting circuit 408 and driving the alarm 407.

The operation of a sensing circuit will now be described with reference to the exemplary embodiment of FIG. 4. When there is no voltage applied to the first input 403a of the NAND gate 403, the second input 403b of the NAND gate 403 is at the voltage Vcc of the battery 412, the discharge capacitor 404a is fully charged via the charging resistor 404b and the output 403c of the NAND gate 403 is at Vcc 412a potential. In this state, the detector consumes reduced power because logic circuits (e.g. the NAND gate 403 and the buffer circuits 406) can be configured to consume very little power and few, if any, active circuits (e.g. alarm 411 and transmitting circuit 408) are driven. Thus, the detector is in a standby mode for sensing the occurrence of fluid the first probe 401 and second probe 418.

When the first input 403a of the NAND gate 403 receives a potential from the first probe 418 via the fluid to the second probe 101 and this potential exceeds the switching level of the NAND gate 103 (e.g., both inputs 403a and 403b of the NAND gate 403 are at the Vcc potential), the NAND gate 403 will change the output 403c to a ground potential. This will cause the discharge capacitor 404a to discharge through the discharge diode 404c and the discharging resistor 404d, which is less resistive than the charging resistor 404b, into the hysteresis of the NAND gate 403. When the discharge capacitor 404a discharges down to the switching level of the NAND gate 403, the NAND gate will switch the output 403c of the NAND gate 403 to a Vcc potential 412a and start recharging the discharge capacitor 404a through the charging resistor 404b. This oscillation will continue as long as the first input 403a of the NAND gate 403 receives a potential from the first probe 418 via the fluid to the second probe 401 that exceeds the switching level of the NAND gate 403. The discharging resistor 404d and the diode 404c determines the pulse time for the output signal 405. The charging resistor 404b respectively determine the period of oscillation for the output signal 405.

The transmitting circuit 408 of the exemplary embodiment in FIG. 4 emits a signal each time the transmitting circuit 408 is enabled by the buffered output signal from the sensing circuit 402. Therefore, the transmitting circuit 408 emits a pulsed signal 410. The transmitting circuit 408 consumes very little power until it is enabled. The pulsed signal 410 is emitted from a transmitter 411 that can be encoded by a set of switches 409 that determine types of encoding for the pulsed signal 410 emitted from the transmitting circuit 410. The transmitting circuit 408 can encode the pulsed signal 410 in analog or digital so as to only operate receiving circuits which are likewise encoded to receive the pulsed signal 410. An exemplary pulsed signal is approximately 100 milliseconds at intervals (or with a period of oscillation) of about 1 minute.

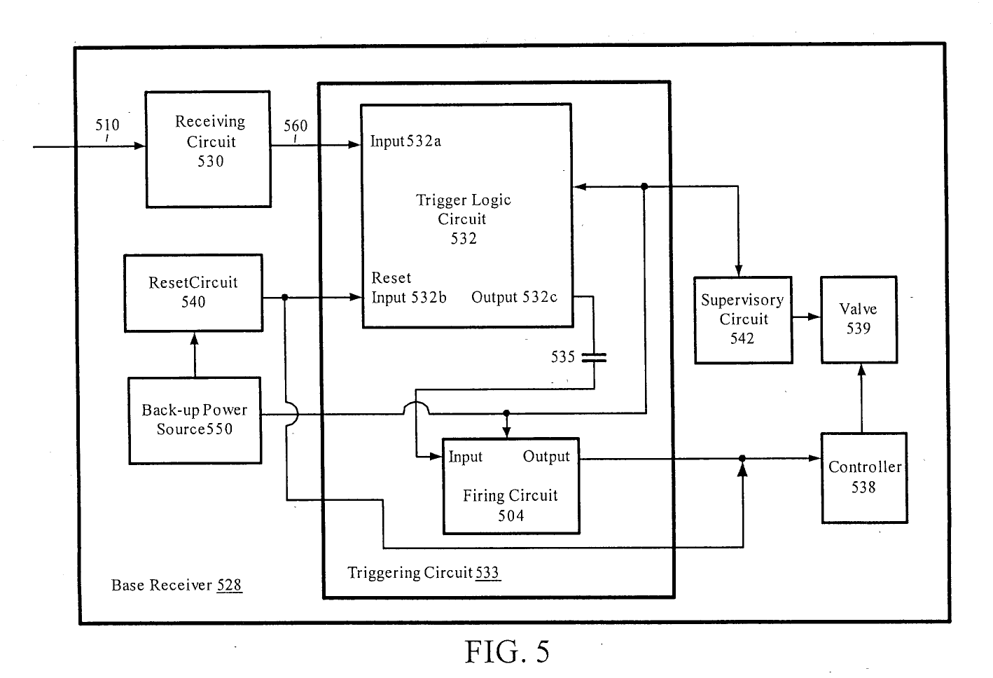

An exemplary embodiment of a base receiver is shown in FIG. 5 as a base receiver 528 that includes a receiving circuit 530 for receiving a pulsed signal 510 from a transmitter and has an output for emitting a trigger signal 560 to enable a triggering circuit 533 connected to the receiving circuit 530. As shown in exemplary embodiment of FIG. 5, the triggering circuit 533 includes a trigger logic circuit 532 having an input 532a connected to the output of the receiving circuit, a reset input 532b, and a output 532c. The triggering circuit 533 includes a first capacitor, which is represented in the exemplary embodiment of FIG. 5 as a firing capacitor 535 that has a first node connected to the output 532c of the trigger logic circuit 532. The triggering circuit includes a firing circuit 534 having an input connected to the second node of the firing capacitor 535 and an output for activating a controller 538 that actuates the valve 539. As shown in the exemplary embodiment of FIG. 5, the base receiver 528 can include a reset circuit 540 for resetting the trigger logic circuit and reverse actuating the valve via the controller 538. The base receiver 500 in the exemplary embodiment of FIG. 5 can include a back-up power source 550 for the base receiver 500 and the controller 538 when, for example, an external power source is insufficient to actuate the valve 539. A supervisory circuit 542 for monitoring the position of the valve 539 can also be included in the base receiver 528.

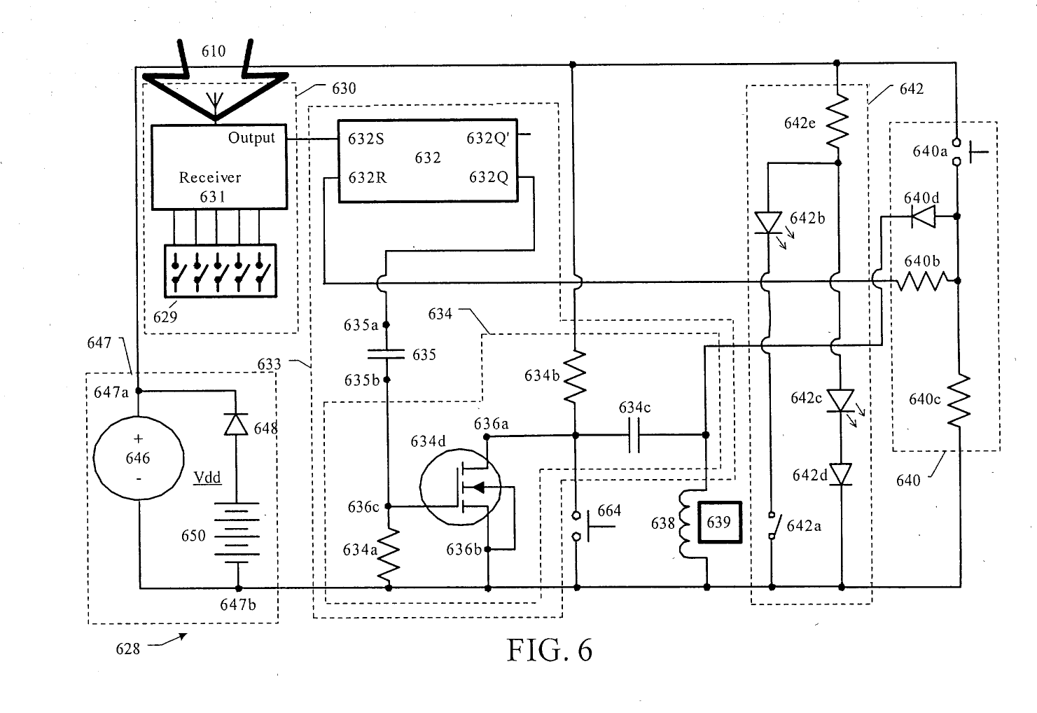

FIG. 6 is a schematic for an exemplary embodiment of a base receiver represented as base receiver 628 having a triggering circuit 633 that includes a trigger logic circuit 632, a firing capacitor 635 and firing circuit 634. The trigger logic circuit 532 is, for example, a flip-flop having an input 632S connected to the output of the receiver circuit 630, a reset input 632R, a first output 632Q and a second output 632Q′. In the alternative or in addition, either or both the first output 632Q and second output 632Q′ can be used to drive internal or external alarms.

The firing capacitor 635, as shown in the exemplary base receiver 628 of FIG. 6, has a first node 635a and a second node 635b. The first node 635a is connected to the first output 632Q of the trigger logic circuit 632. The second node 635b is connected to the firing circuit 634.

The base receiver 628 in the exemplary embodiment of FIG. 6 contains a power source 647 of Vdd with a potential node 647a and common ground node 647b. The power source 647 can be a battery or an external power source. In another alternative, as shown in FIG. 6, the power source 647 can be an external power source 646 that is connected to or contains a battery 650 as a back-up power supply. If an external power source with a battery as a back-up power supply is used, an isolation diode 648 can be used to isolate the back-up power supply 650 from the external power source 646. The back-up power supply 650 provides power Vdd to the base receiver in the event that, for example, the external power source 646 is insufficient (e.g., becomes disconnected or fails) in providing enough power for the controller to actuate the valve 639. For example, the backup power source 650 can provide power for the supervisory circuit 642, the firing circuit 642, the reset circuit 640, as well as, the controller 638. The trigger logic circuit 632 and receiving circuit 630 may operate at different potential than the supervisory circuit 642, the firing circuit 642 and the reset circuit 640. A voltage regulator can be included to deliver the appropriate potential to the trigger logic circuit 632 and receiving circuit 630 from the power source 647.

As shown in the exemplary base receiver 628 of FIG. 6, a firing circuit 634 for applying a voltage to the controller 638 includes a biasing resistor 634a, a load resistor 634b, a storage capacitor 634c and an electrical switch 634d. The biasing resistor 634a is connected between common ground 647b (e.g. negative terminal of battery 650) of the base receiver 628 and the second node 635b of the firing capacitor 635. The electrical switch 634d, for example a field effect transistor, has a first terminal 636a, a second terminal 636b connected to common ground 647b of the base receiver 628 and a gate 636c connected to the second node 635b of the firing capacitor 635. The storage capacitor 634c is connected between the controller 638 and the first terminal 636a of the electrical switch 634d. A load resistor 634b is connected between the power source Vdd 647a for the base receiver 628 and the first terminal 636a of the electrical switch 634d.

The base receiver 628 in the exemplary embodiment of FIG. 6 includes a reset circuit 640 for resetting the trigger logic circuit 632 and reverse actuating the valve 639 via the controller 638. The reset circuit 640 includes a reset switch 640a that connects the power source Vdd 647a of the base receiver 628 to the storage capacitor 634c via a reset isolation diode 640d. The reset switch 640a can also provide Vdd 647a between a first reset resistor 640b and a second reset resistor 640c set up as a voltage divider. The first reset resistor 640b is connected between the reset switch 640a and the reset input 632R of the trigger logic circuit 632. The second reset resistor 640c is connected between the switch 640a and the common ground of the base receiver 647b. The first and second reset resistors 640b and 640c allow the proper reset voltage to be applied to the reset input 632R of the trigger logic circuit 632 when Vdd 647a is larger than the maximum operational voltages (i.e. Vcc) of the trigger logic circuit 632.

The base receiver 628 in the exemplary embodiment of FIG. 6 includes a supervisory circuit 642 for indicating the position of the valve 639. The supervisory circuit includes a load resistor 642e connected between to a branching circuit and Vdd 647a of the base receiver 628. The branching circuit has a first branch with a red light emitting diode 642c and a load diode 642d connected in series to common ground 647b of the base receiver 628, and a second branch with green light emitting diode 642b and sensor switch 642a connected in series to common ground 647b of the base receiver 628. As shown in FIG. 2, the sensor switch 242a can be a Hall magnetic sensor that detects the actual position of the valve 239 or any desired device to detect the position of the valve. For example, a magnetically operated reed switch can be utilized, as can a mechanically activated switch or any other device that can function to achieve the desired detection.

The receiving circuit 630, as shown in the exemplary embodiment of FIG. 6, has an output connected to the input 632S of the trigger logic circuit 632 (e.g. a flip-flop). When the receiver circuit 630 receives a pulsed signal 610 from a transmitter, it enables the trigger logic circuit 632 to activate the controller 638 via the firing capacitor 635 and the firing circuit 634. The pulsed signal 610 received by the receiver 630 can be encoded. A set of switches 629 in the receiver circuit 630 determine the type or types of encoding that receiver 631 will accept, and thus enable the triggering circuit 633 to activate the controller 638. The receiver 631 can accept signals that are encoded in analog or digital so as to only enable the triggering circuit 633 when likewise encoded signals are received. The receiver 631 can accept signals from several different transmitters and emit a trigger signal to activate the controller 638.

In operation, when the receiving circuit 630 receives pulsed signal 610, a trigger signal is outputted to the input 632S of the flip-flop 632. The trigger logic circuit 632 (e.g. flip-flop) outputs a signal from the output 632Q that momentarily turns on the field effect transistor 636 because of the firing capacitor 635. Turning on the field effect transistor 636 connects one side of the storage capacitor 634c to common ground 647b. Because the storage capacitor 634c is initially charged, this will place a negative voltage (e.g. −Vdd) on the controller 638 and actuate the valve 639. The valve will remain in the actuated position until the reset switch 640a is pushed. When the reset switch 640a is pushed a positive voltage (e.g. +Vdd) is placed on the controller 638 and reverse actuates the valve 639.

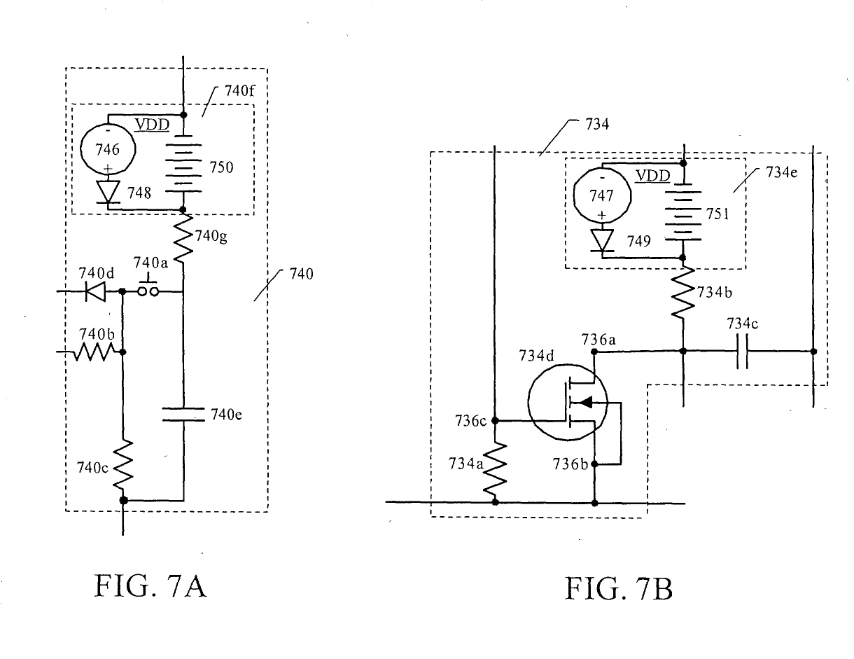

FIG. 7A is an exemplary schematic of an alternative reset circuit 740 for the exemplary embodiment of a base receiver shown in FIG. 6. The reset circuit 740, like the reset circuit 640 in FIG. 6, resets a trigger logic circuit and reverse actuates a valve via a controller when the switch 740a is closed. In contrast to reset circuit 640 of FIG. 6, the reset circuit 740 utilizes a reset voltage for activating the controller to reverse actuate the valve that is a larger voltage than an activation voltage used in the firing circuit for activating a controller to actuate the valve. The larger reset voltage is used, for example, to overcome water pressure when opening a valve. The larger reset voltage can be from a solid state voltage doubler or from both the power source Vdd 647, as shown in FIG. 6, and a reset power source VDD 740f, as shown in FIG. 7A. The reset power source 740f can be a battery or another external power source. In another alternative, as shown in FIG. 7A, the reset power source 740f can be another external power source 746 that is connected to or contains a battery 750 as a back-up power supply. If another external power source with a battery as a back-up power supply is used, an isolation diode 748 can be used as shown in FIG. 7.

The charging capacitor 740e is charged through a charging resistor 740g. by the reset power source VDD 740f and the power source Vdd 647 shown in FIG. 6. The use of the of the charging capacitor 740e and charging resistor 740g prevents abuse of a controller from a constant application of the larger reset voltage (e.g. VDD+Vdd). The reset isolation diode 740d, the first reset resistor 740b and second reset resistor 740c in FIG. 7A respectively perform the same functions as described for the reset isolation diode 640d, the first reset resistor 640b and second reset resistor 640c in FIG. 6.

FIG. 7B is an exemplary schematic of an alternative firing circuit 734 for the exemplary embodiment of a base receiver shown in FIG. 6. The firing circuit 734, like the firing circuit 634 in FIG. 6, includes a biasing resistor 734a, a load resistor 734b, a storage capacitor 734c and an electrical switch 734d. In contrast to the firing circuit 634 of FIG. 6, the firing circuit 734 utilizes an activation voltage for activating a controller to actuate the valve that is a larger voltage than a reset voltage used in the reset circuit for activating the controller to reverse actuate the valve. The larger activation voltage is used, for example, to overcome water pressure when opening a valve. The larger activation voltage can be from a solid state voltage doubler, or from combining the voltages of two power sources. For example, the power source Vdd 647, as shown in FIG. 6, and an activation power source VDD 734e, as shown in FIG. 7B will create a larger activation voltage (e.g. Vdd+VDD) across the electrical switch 734d. The activation power source 734e can be a battery or another external power source. In another alternative, as shown in FIG. 7B, the activation power source 734e can be another external power source 747 that is connected to or contains a battery 751 as a back-up power supply. If another external power source with a battery as a back-up power supply is used, an isolation diode 749 can be used, as shown in FIG. 7B.

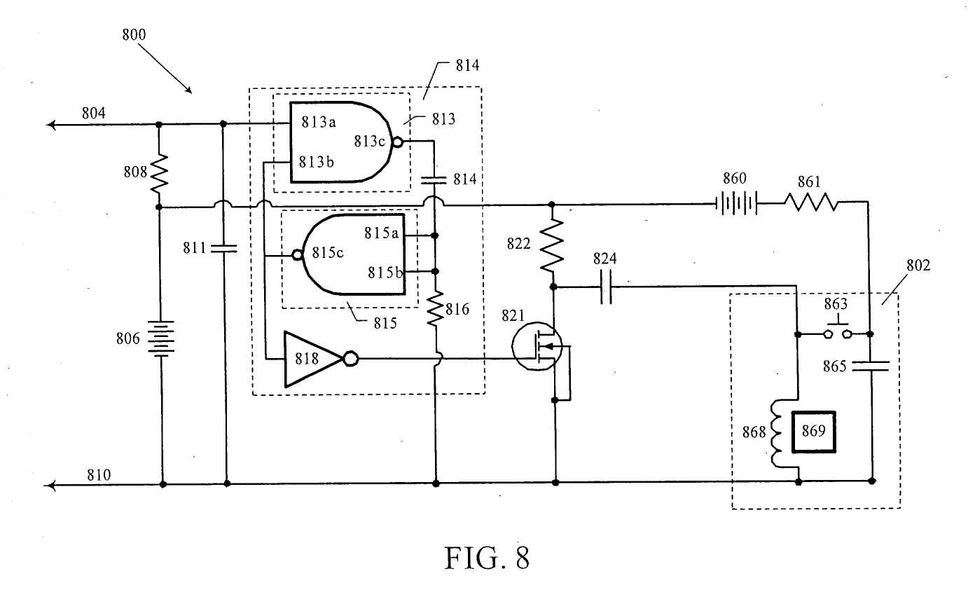

FIG. 8 is an exemplary embodiment of a detector 800 using two different voltages for actuating a valve 869 that controls fluid flow. The two different voltages are applied to a controller 868 for actuating the valve 869. The detector 800 includes a first probe 804 and a second probe 806. The first probe 804 is connected to a sensing circuit 814 for detecting a voltage change between the first and second probes due to the presence of fluid. The sensing circuit 814 triggers a switch, such as transistor 821, that discharges an actuating voltage from an actuation capacitor 824. The actuating voltage to activates the controller 868 such that the valve 869 is actuated. Another switch, such as reset switch 863, discharges a reverse actuating voltage from a reverse actuation capacitor 865. The reverse actuating voltage activates the controller 868 such that the valve 869 is reverse actuated.

As shown in FIG. 8, the first probe 804 is connected to a power source 806 through an input impedance resistor 808, and to the first input 813a of the sensing circuit 814. The input impedance resistor 808 and the power source 806 are connected between the first probe 804 and a second probe 810. A radio frequency blocking capacitor can also be connected between the first probe 804 and the second probe 810. The actuation capacitor 824 is charged by the power source 806 through resistor 822. The reverse actuation capacitor 865 is charged by both power source 806 and power source 860 through a resistor 861.

The sensing circuit 814 includes a first NAND gate 813 with an output 813c connected through a capacitor 814 to the inputs 815a and 815b of a second NAND gate 815. A resistor 816 is connected between the second probe 810 and the inputs to the second NAND gate 815. The output 815c of the second NAND gate 815 is connected to the second input 813b of the first NAND gate 813 and to inverter 818. The switch, such as transistor 821, that discharges an actuating voltage from an actuation capacitor 824 is connected to the inverter 818.

Many aspects of the invention are described as particular types of logic circuits. It should be recognized that a logical function can be performed by specialized circuits (e.g., discrete logic gates interconnected to perform the logical function), an integrated circuit within a chip (e.g. a flip-flop chip), a microprocessor or by a combination thereof. Exemplary embodiments can be embodied entirely within different forms of circuitry such as a Field Programmable Gate Array (FPGA), components on a circuit board, IC chips and components on a circuit board, IC chips and components on interconnected discrete circuit boards, or any combination thereof.

The invention has been described with reference to a particular embodiments. However, it will be readily apparent to those skilled in the art that it is possible to embody the invention in specific forms other than those of the embodiment described above. This can be done without departing from the spirit of the invention. The embodiments described herein are merely illustrative and should not be considered restrictive in any way. The scope of the invention is given by the appended claims, rather than the preceding description, and all variations and equivalents which fall within the range of the claims are intended to be embraced therein.

What is claimed is:

1. A system that senses for fluid and activates a controller in response to sensing the fluid comprising:
a controller for actuating a valve used to control fluid flow;
at least one detector including:
a sensing circuit for detecting a voltage change due to the fluid and generating an oscillating output signal;
a transmitting circuit connected to the sensing circuit for transmitting a pulsed signal in response to the oscillating output signal; and
a base receiver including:
a triggering circuit for activating the controller;
a receiving circuit for receiving the pulsed signal from the transmitting circuit and enabling the triggering circuit.

2. The system according to claim 1, wherein the controller comprises:
one of a solenoid and motor to actuate the valve.

3. The system according to claim 1, wherein the base receiver comprises:
a back-up power source for supplying power to the base receiver base and the controller when an external power source is insufficient to actuate the valve.

4. The system of claim 1, wherein more than one detector can be used with the base receiver to activate the controller.

5. The system of claim 1, wherein the sensing circuit includes a logic gate and an output signal control circuit for controlling period and oscillation of the oscillating output signal.

6. The system according to claim 1, wherein the transmitting circuit of the detector includes a transmitter and a first set of switches that determine types of encoding for the pulsed signals from the transmitter and the receiving circuit of the base receiver includes a receiver and a second set of switches that determine types of encoded pulsed signals that the receiver will accept.

7. The system of claim 1, wherein the triggering circuit includes a trigger logic circuit and a firing circuit for applying a voltage to the controller, wherein a capacitor is connected in between the trigger logic circuit and the firing circuit.

8. The system according to claim 1, wherein the base receiver further comprising:
a supervisory circuit for indicating positions of the valve.

9. A detector for sensing fluid comprising:
a first probe and a second probe for sensing a fluid, wherein a voltage is applied to the second probe from the first probe when fluid is sensed;
a logic gate having a first input connected to the second probe, a second input and an output;
an output signal control circuit connected to the second input and to the output of the logic gate for controlling an output signal from the logic gate; and
a transmitting circuit for transmitting a pulse signal representing sensing of the fluid based upon the output signal from the output of the logic gate.

10. The detector of claim 9, wherein the logic gate is a NAND gate.

11. The detector of claim 9, wherein the output signal controller circuit comprises:
a first capacitor connected between common ground and the second input of the logic gate;
a first resistor connected between the first capacitor and the output of the of the logic gate; and
a first diode and a second resistor connected in series in between the first capacitor and the output of the logic gate.

12. The detector of claim 9 further comprising:
a buffer circuit that is connected between the transmitting circuit and the output of the logic gate for buffering the output signal from the transmitting circuit.

13. The detector of claim 12, wherein the buffer circuit comprises:
a first inverter connected between the transmitting circuit and the output of the logic gate.

14. A base receiver for activating a controller comprising:
a receiving circuit for receiving a signal and having an output for emitting a trigger signal;
a trigger logic circuit having an input connected to the output of the receiving circuit, a reset input and a second output;
a first capacitor having a first node connected to the output of the trigger logic circuit and a second node; and
a firing circuit having an input connected to the second node of the first capacitor and an output for activating a controller to actuate a valve.

15. The base receiver according to claim 14, wherein the trigger logic circuit is a flip-flop type logic circuit.

16. The base receiver according to claim 14, comprising:
a reset circuit connected to the reset input and to the controller for resetting the trigger logic circuit and activating the controller to reverse actuate the valve.

17. The base receiver according to claim 16, wherein a reset voltage used in the reset circuit for activating the controller to reverse actuate the valve is larger than an activation voltage used in the firing circuit for activating a controller to actuate the valve.

18. The base receiver according to claim 16, wherein an activation voltage used in the firing circuit for activating a controller to actuate the valve is larger than a reset voltage used in the reset circuit for activating the controller to reverse actuate the valve.

19. The base receiver according to claim 14, wherein the firing circuit comprises:
a first resistor connected between common ground and the first capacitor;
an electrical switch with a first terminal, a second terminal connected to common ground and a gate connected to a point between the first capacitor and the first resistor;
a second capacitor connected between the controller and the first terminal of the electrical switch; and
a second resistor connected between a power source and the first terminal of the electrical switch.

20. A fluid detection system for activating a controller in response to sensing a presence of fluid comprising:
a valve for controlling fluid flow;
a controller for actuating the valve;
a first and second probe;
a sensing circuit for detecting a voltage change between the first and second probe due to the presence of fluid;
a first capacitor for discharging a first voltage to activate the controller such that the valve is actuated; and
a second capacitor for discharging a second voltage to activate the controller such that the valve is reverse actuated.
